(19) United States
(12) Patent Application Publication
(10) Pub. No.: US 2004/0109813 A1
(43) Pub. Date: Jun. 10, 2004

(54) Process and device for upgrading current emission

(75) Inventors: Kuo-Chu Hwang, Houbi Hsiang (TW); Sheng-Chin Kung, Taipei (TW)

Correspondence Address: KLARQUIST SPARKMAN, LLP, 121 SW SALMON STREET, SUITE 1600, PORTLAND, OR, 97204, US

(73) Assignee: National Tsing Hua University

(21) Appl. No.: 10/313,757

(22) Filed: Dec. 5, 2002

(51) Int. Cl. B29C 57/00; B29C 71/02

(52) U.S. Cl. 423/447.1; 264/82; 264/320; 264/345

(57) ABSTRACT

An art is provided to realize a current emitting device capable of emitting current of higher density under the same or lower onset emission voltage. The current emitting device is preferably an array of carbon nanotubes or a film including carbon nanotubes. The art is based on oxidizing a current emitting device composed of material including carbon, until the current emitting device has at least part thereof changed in shape. The current emitting device thus processed works better with a display, or becomes capable of emitting current of higher density under the same or lower onset emission voltage. As far as experiments showed, the emitted current density achieved by the art can be eight times the amount emitted by an array of nanotubes having not been processed according to the art, and the onset emission voltage can be lowered by the art from 0.8 V/μm to 0.5 V/μm.

### FIELD OF THE INVENTION

The present invention generally relates to a current emitting device, and particularly to a carbon nanotube used for emitting electrons, and to a process applied thereto.

### BACKGROUND OF THE INVENTION

Pretty much effort has been made by many to explore or discover new schemes for emitting electrons to drive a display screen or another device. This is particularly crucial when application of a display to a mobile apparatus becomes popular and size minimization of apparatus including a display is eagerly expected. The most significant one among the new schemes explored or discovered for this purpose is to have a current emitting device easily made to be of smaller size while being capable of emitting electrons for driving a display screen, without need of higher onset emission voltage or even with lower onset emission voltage in order to minimize voltage source capacity. Obviously a current emitting device of smaller size, and a voltage source of smaller capacity and/or lower voltage level, both will significantly contribute to the size minimization of an apparatus including a display screen. An apparatus requiring lower operating voltage (due to lower onset emission voltage for emitting electrons to drive the display screen) consumes less energy, resulting in longer operating time period on the basis of the same battery capacity. These are particularly crucial to a mobile apparatus with a display thereon.

To realize a current emitting device with features described above, many kinds of means have been tried, among which a carbon nanotube array or film (i.e., an array composed of a plurality of carbon nanotubes, or a film including a plurality of carbon nanotubes) has received significant attention. However wishfully a carbon nanotube is used as a current emitting device, it suffers from its incapability of emitting sufficient electrons to drive a display screen under a realizable onset emission voltage. It can thus be understood that a critical condition for a carbon nanotube to be used as a current emitting device for driving a display screen is its capability of emitting sufficient electrons to drive a display screen under a realizable onset emission voltage.

As carbon nanotubes have been so far regarded as the best potential current emitting device for driving a display screen (particularly if the display is expected to be as small as possible, or to be installed where capacity and/or voltage-level of power source is limited), attempts have been made by scientists to have a carbon nanotube capable of emitting more electrons under an onset emission voltage which is more realizable. An impressive one among the attempts was described in a paper disclosed by Lee and his co-workers. According to Lee's paper, carbon nanotube arrays were grown on iron/silica substrate, and then peeled off and reversed with its bottom side (originally contacting the substrate) facing upward, resulting in open-ended carbon nanotubes, leading to a very low turn-on voltage of 0.6-1.0 V/μm (conventional onset emission voltage of vertically aligned carbon nanotubes formed by CVD process is reported to be in the range of 4-0.9V/μm). Although the attempt achieves low onset emission voltages, the required process includes peeling off and reversing an array or film of nanotubes, which requires sophisticated skill and is difficult to implement, particularly when commercializtion of a product is concerned. This is why a lot of attempts are still being made to achieve a current emitting device which can be easily produced to emit sufficient electrons for driving a display screen under an economically realizable onset emission voltage. One of the most promising among those attempts is to have carbon nanotubes or the like which can be easily formed and better applied to practical products.

For more information about carbon nanotubes, reference to U.S. Pat. Nos. 6,303,094 and 6,380,671, and inventor's paper published Jun. 24, 2002 shall be made.

### SUMMARY OF THE INVENTION

It is therefore an object of the present invention to provide a process applied to a current emitting device composed of material including carbon, for the current emitting device to be capable of working better with a display screen, particularly a display on a mobile or compact apparatus, or those on an apparatus with power source limited to lower voltage level or lower capacity.

It is therefore another object of the present invention to provide a process applied to an object composed of material including carbon, for the object to work better with a display.

It is therefore a further object of the present invention to provide a process applied to an object composed of material including carbon, for the object to be capable of emitting more electrons (i.e., to raise its current emission capability), or be able to emit electrons under lower onset emission voltage (i.e., under smaller applied electric field).

Another further object of the present invention is to provide a current emitting device easily made to be capable of working better with a display, particularly a display on a mobile or compact apparatus, or those on an apparatus with power source limited to lower voltage level or lower capacity.

Other features, advantages, and objects may become apparent from the following detailed description with reference to the drawings. In this disclosure, “onset emission voltage for emitting a current” means the electric field required for emitting the current, and “turn-on voltage” means the minimum electric field for any current emission.

One aspect of the present invention may be represented by a process which is applied to a current emitting device having an end portion and composed of material including carbon, for the current emitting device to work better with a display or any apparatus requiring electronic current to be emitted from an object. The process comprises a step of oxidizing the current emitting device at an operating temperature until the shape of at least part of the end portion changes, wherein the operating temperature is higher than ambient temperature. Here the current emitting device may be in the shape of a tube or a nanotube or a ball (such as a spherical ball or an elliptical ball) with smaller size, or may even be in the shape of a half ellipsoid, and may stretch out (or be grown) from a substrate or a carrier to have the end portion outside the substrate (or the carrier). For example, the end portion may be a surface facing a display screen which is to be driven (i.e., collided) by the electrons emitted from the current emitting device. The current emitting device may be regarded as having another end portion on or connecting the substrate (or the carrier), or regarded as being grown from the substrate.

Another aspect of the present invention may be represented by a process which is applied to a current emitting device composed of material including carbon, for the current emitting device to work better with a display or any apparatus requiring emission of electronic current. Here the current emitting device may have no portion to be regarded as an end. For example, the current emitting device is in the shape of a ball, or in the shape similar to a ball, or a half ball with its flat surface on a substrate or a carrier. The direction the current emitting device emits electrons is not necessarily limited to a certain one or a certain range, and the emission of electrons is not necessarily from an end thereof.

If a current emitting device composed of material including carbon is oxidized by a fluid including O₃, the operating temperature for the oxidization to result in a current emitting device capable of working better with a display screen (or emitting current of higher density) can be as low as −50° C. (negative 50° C.), which simply is any temperature in the real world. Therefore a further aspect of the present invention may be represented by a process of oxidizing the current emitting device by a fluid including O₃ at any temperature in the real world, to make the current emitting device capable of emitting current of higher density under the same or lower onset emission voltage.

A current emitting device composed of material including carbon, after being oxidized according to the present invention, will always have carboxylic acid group (—COOH) and/or hydroxyl group (—OH) and/or ketone group (>C═O) on at least part of its surface. Therefore another further aspect of the present invention is represented by a current emitting device composed of material including carbon, with its surface at least partly having carboxylic acid group (—COOH) and/or hydroxyl group (—OH) and/or ketone group (>C═O) thereon.

For a current emitting device composed of material including carbon, the cause of changing in shape to be capable of emitting electrons of higher density under the same or lower onset emission voltage, is the cleavage of some C═C double bonds of carbon therein. The process according to the present invention is the unique art so far to cause the cleavage of C═C double bonds in a current emitting device composed of material including carbon, for the current emitting device to work better with a display, or to be capable of emitting larger current under the same or lower onset emission voltage. Therefore another still further aspect of the present invention is represented by a process applied to a current emitting device composed of material including carbon, to split the C═C double bonds of the current emitting device, so that the current emission capability of the current emitting device improves, i.e., the current emitting device becomes capable of emitting current of higher density under the same or lower onset emission voltage.

Obviously the application of a current emitting device processed according to the present invention is not necessarily limited to a display. Actually it may be used wherever the current emitted from an object plays a role.

The present invention may best be understood through the following description with reference to the accompanying drawings, in which:

### BRIEF DESCRIPTION OF THE DRAWINGS

FIG. 1 is a diagram representing an image picture of two carbon nanotubes taken by a TEM (transmission electron microscope).

FIG. 2 is a diagram representing a picture view of an oxidized carbon nanotube taken by a TEM (transmission electron microscope), wherein oxidization was embodied according to the present invention.

FIG. 3 is a diagram representing another picture view of an oxidized carbon nanotube taken by a TEM (transmission electron microscope), wherein oxidization was embodied according to the present invention.

FIG. 4 is a diagram representing a further picture view of an oxidized carbon nanotube taken by a TEM (transmission electron microscope), wherein oxidization was embodied according to the present invention.

FIG. 5 is a diagram representing (Emitted Current-Emission Voltage) plots of an original array of carbon nanotubes and those having been oxidized according to the present invention.

FIG. 6 is a diagram representing plots of ln(J/E²) vs 1/E according to Fowler-Nordheim field emission theory, for an original array of carbon nanotubes and those having been oxidized according to the present invention.

FIG. 7 is a diagram representing (Emitted Current-Emission Voltage) plots of an original array of carbon nanotubes and those having been oxidized by O₃ and BR₂ according to the present invention.

### DETAILED DESCRIPTION OF THE PREFERRED EMBODIMENTS

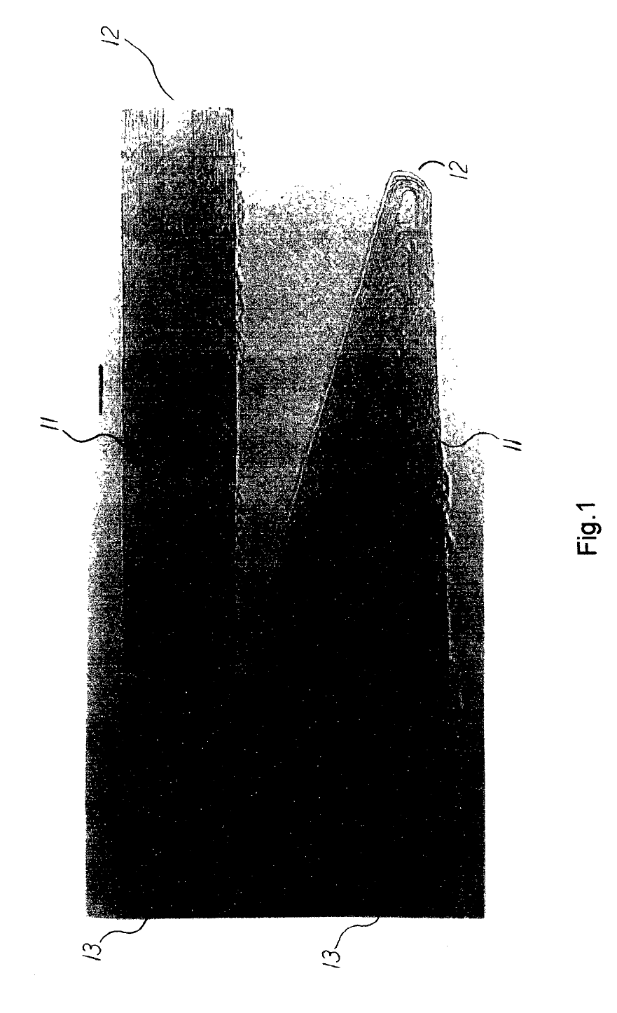

In FIG. 1, a carbon nanotube 11 has an end portion 12 and can be used as a current emitting device to emit electrons. For example, an array of carbon nanotubes 11 may be used to emit electrons for driving a display screen (not shown in figures), i.e., the emitted electrons collide with a display screen to form images on the display screen. Carbon nanotube 11 may be regarded as having another end portion 13 on or connecting a substrate or carrier (not shown in figures), or regarded as being grown from a substrate.

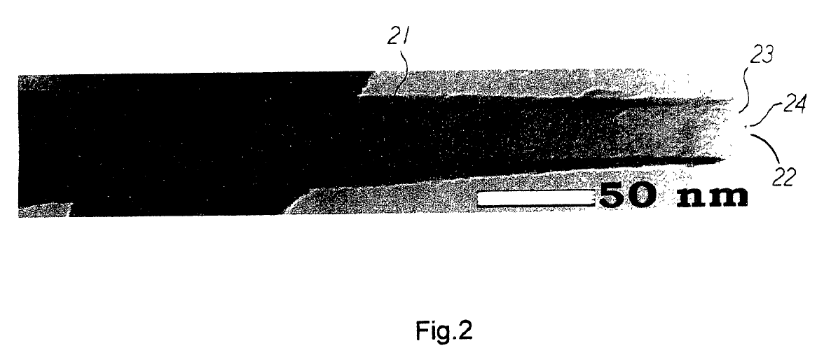

FIG. 2 shows a view of a carbon nanotube 21 which has been oxidized according to the present invention to have its end portion 22 changed in shape. For example, at least a part 23 of end portion 22 becomes depressed, and at least a part 24 thereof turns to be in the shape of a tip or similar to the shape of a tip, thereby the current emission capability of the carbon nanotube improves and/or the onset emission voltage thereof is lowered.

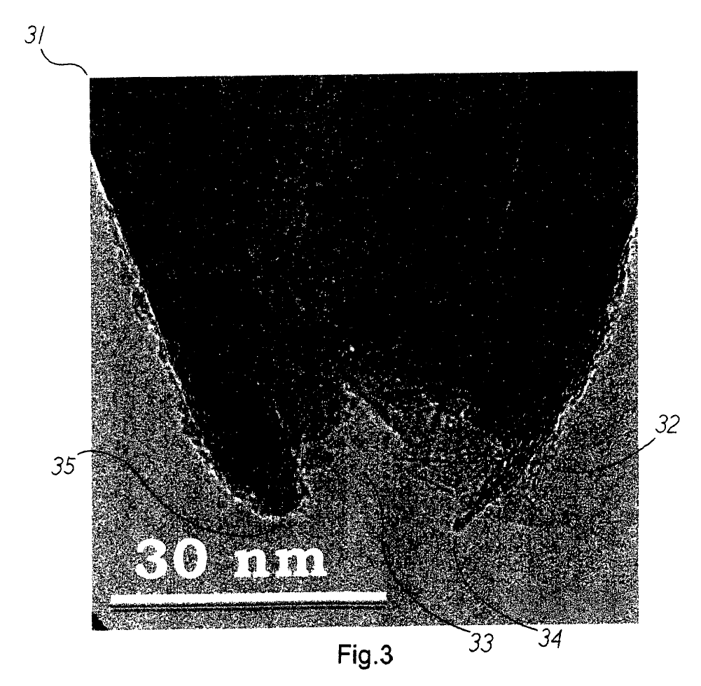

FIG. 3 shows a view of a carbon nanotube 31 which has been oxidized according to the present invention to have its end portion 32 changed in shape. For example, at least a part 33 of end portion 32 turns to be depressed, and at least parts 34 and 35 thereof turn to be in the shape of a tip or similar to the shape of a tip, thereby the current emission capability of the carbon nanotube improves and/or the onset emission voltage thereof is lowered.

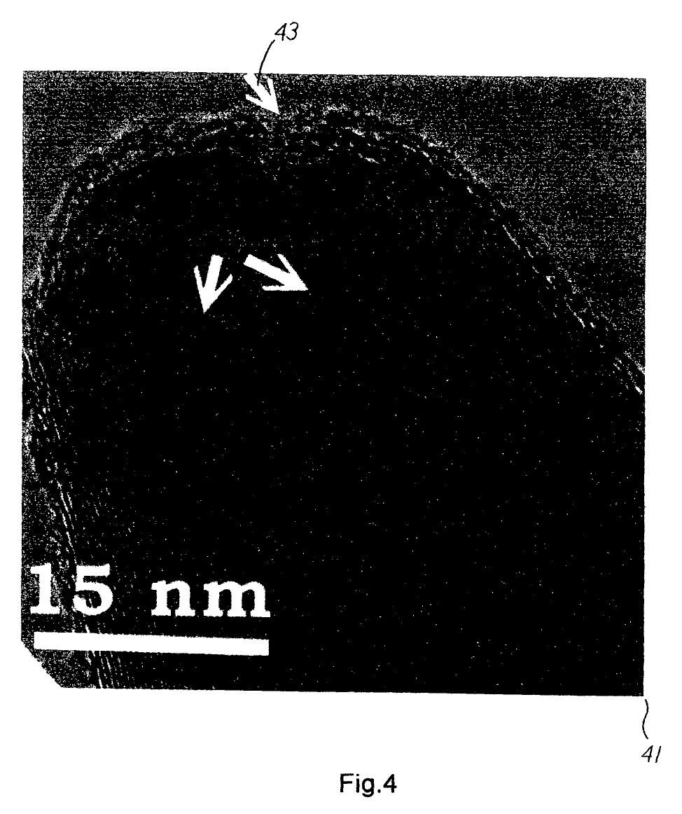

FIG. 4 shows a view of a carbon nanotube 41 which has been oxidized according to the present invention to have at least the parts (indicated by three white arrows 43) thereof turned to be depressed, thereby the current emission capability of the carbon nanotube improves and/or the onset emission voltage thereof is lowered.

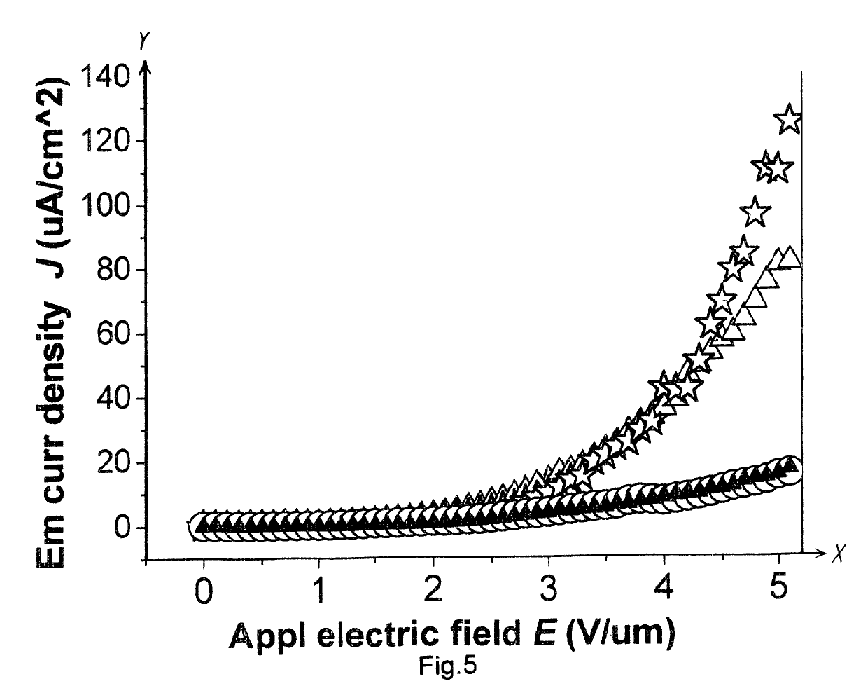

FIG. 5 shows (Emitted Current-Emission Voltage) plots of an original array of carbon nanotubes and those oxidized according to the present invention by gaseous fluid including Oxygen (O₂) Y axis represents emission current density J (unit: μA/cm²), and X axis represents applied electric field E (unit: V/μm). The curve represented by open circles ◯ is for an array of original carbon nanotubes (not oxidized according to the present invention). The curve represented by closed triangles ▴ is for an array of carbon nanotubes having been oxidized for 10 minutes at an operating temperature of 400° C. by gaseous fluid including Oxygen, or oxidized for 10 minutes by gaseous fluid including Oxygen and being at an operating temperature of 400° C. The curve represented by open triangles A is for an array of carbon nanotubes having been oxidized for 20 minutes at an operating temperature of 400° C. by gaseous fluid including Oxygen, or oxidized for 20 minutes by gaseous fluid including Oxygen and being at an operating temperature of 400° C. The curve represented by open stars ☆ is for an array of carbon nanotubes having been oxidized for 25 minutes at an operating temperature of 400° C. by gaseous fluid including Oxygen, or oxidized for 25 minutes by gaseous fluid including Oxygen and being at an operating temperature of 400° C.

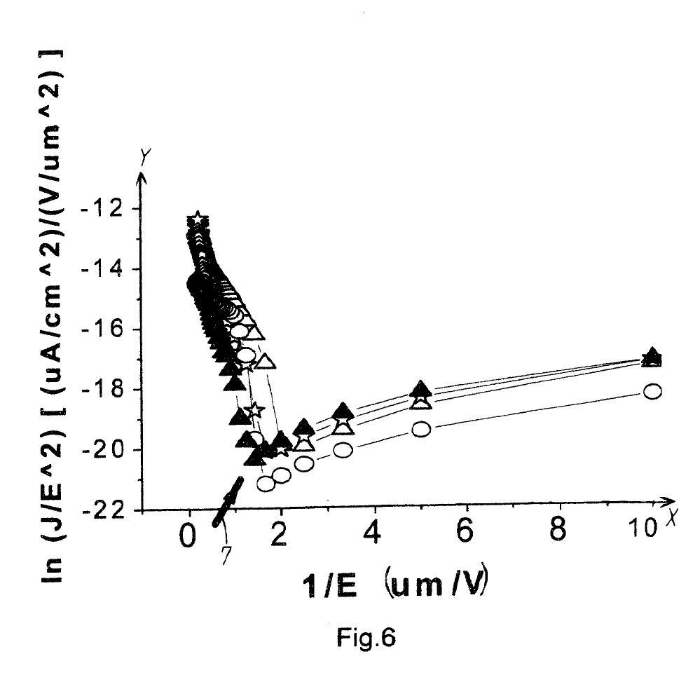

It can be seen from FIG. 5 that in terms of current emission capability of the nanotubes, the oxidization of the nanotubes for 10 minutes by gaseous fluid including Oxygen at an operating temperature of 400° C. makes no much difference from the original nanotubes (compare the two curves respectively represented by ▴ and ◯), but the oxidizations of the nanotubes for 20 and 25 minutes by gaseous fluid including Oxygen at an operating temperature of 400° C. make significant differences from the original nanotubes (compare the 3 curves respectively represented by Δ, ★, and ◯). For a condition of E (applied electric field)=4.5 V/μm, J (emitted current density) of the original nanotubes (see the curve represented by ◯) is about 9 μA/cm², while the J of the nanotubes having been oxidized for more than 25 minutes by gaseous fluid including Oxygen at a temperature of 400° C. can reach 72 μA/cm² which is 8 times the amount of the original nanotubes. The turn-on voltage for field emission (or current emission), as can be observed from the plots of ln(J/E²) vs 1/E in FIG. 6 according to Fowler-Nordheim field emission theory, decreases from 0.8 V/μm to 0.5 V/μm. These carbon nanotubes may have been grown on a p-Si substrate.

FIG. 6 shows plots of ln(J/E²) vs 1/E according to Fowler-Nordheim field emission theory. In FIG. 6, Y axis represents ln(J/E²) and X axis represents 1/E where J is emitted current density (unit: μA/cm²) and E is applied electric field (unit: V/μm). What are meant by the curves (actually lines) represented by ◯, ▴, Δ, and ☆ in FIG. 6 are on the analogy of those in FIG. 5. The arrow 7 indicates a region of turn-on voltage of field emission (or current emission). It can be seen the turn-on voltage of field emission (or current emission) for the original nanotubes (see line represented by ◯) is about 0.8 V/μm, while the turn-on voltage of field emission (or current emission) for the nanotubes having been oxidized for more than 25 minutes by gaseous fluid including Oxygen at a temperature of 400° C. (see lines represented by Δ, ☆) can be as low as 0.5 V/μm. If the carbon nanotubes are used to drive a display screen (i.e., to emit electrons colliding with the screen for displaying images thereon), and the spacer between the screen and the emission portion of the nanotubes is 200 μm in thickness, the decrease of turn-on voltage of field emission (or current emission) from 0.8 V/μm to 0.5 V/μm means a decrease of required electric field of 60V, which is extremely significant particularly when the nanotubes are used with a display on a mobile apparatus or with any apparatus with limited capacity or voltage-level of power source, or with limited convenience of accepting higher voltage-level.

Although the experiments for the curves in FIGS. 5 and 6 were based on the operating temperature of 400° C., the oxidization to achieve the object of the present invention can actually be implemented for a proper time period at any temperature higher than ambient temperature, preferably higher than or equal to 70° C.

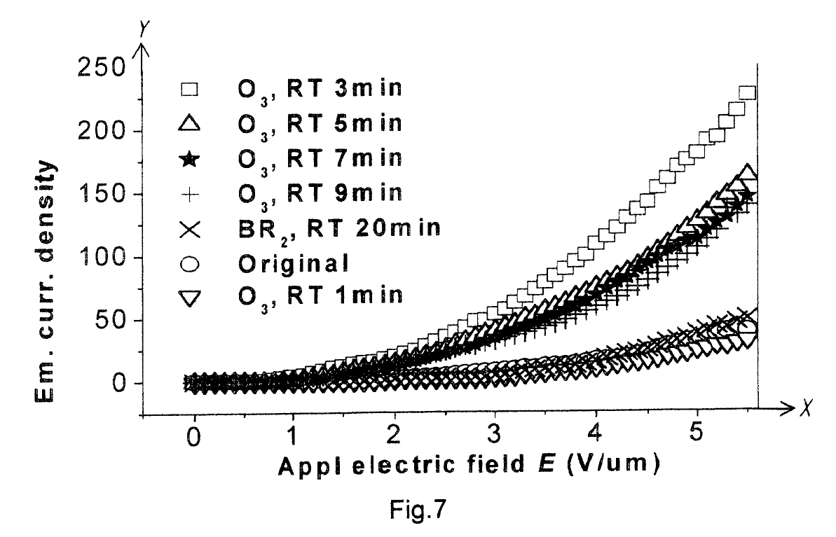

FIG. 7 shows (Emitted Current-Emission Voltage) plots of an original array of carbon nanotubes and those oxidized according to the present invention by gaseous fluid including Ozone (O₃) or Br₂. Y axis represents emission current density J (unit: μA/cm²), and X axis represents applied electric field E (unit: V/μm). The curve represented by open circles ◯ is for an array of original carbon nanotubes (not oxidized according to the present invention). The curve represented by symbols x is for an array of carbon nanotubes having been oxidized for 20 minutes at room temperature by gaseous fluid including Br₂. The curve represented by symbols ∇ is for an array of carbon nanotubes having been oxidized for 1 minutes at room temperature by gaseous fluid including O₃. The curve represented by symbols □ is for an array of carbon nanotubes having been oxidized for 3 minutes at room temperature by gaseous fluid including O₃. The curve represented by symbols Δ is for an array of carbon nanotubes having been oxidized for 5 minutes at room temperature by gaseous fluid including O₃. The curve represented by symbols [symbol] is for an array of carbon nanotubes having been oxidized for 7 minutes at room temperature by gaseous fluid including O₃. The curve represented by symbols+is for an array of carbon nanotubes having been oxidized for 9 minutes at room temperature by gaseous fluid including O₃.

It can be seen from FIG. 7 that in terms of current emission capability of carbon nanotubes, the oxidization of carbon nanotubes for 1 minute by gaseous fluid including O₃ at room temperature, or the oxidization of carbon nanotubes for 20 minutes by gaseous fluid including Br₂ at room temperature, makes no much difference from the original nanotubes (compare the 3 curves respectively represented by ∇, x, and ◯), but the oxidization of the nanotubes for 3 or more minutes by gaseous fluid including O₃ at room temperature makes a significant difference from the original nanotubes (compare the 5 curves respectively represented by □, Δ, [symbol] , +, and ◯). It must be noted that the oxidization of carbon nanotubes for longer time period by gaseous fluid including O₃ at room temperature does not necessarily always result in better capability of emitting electrons. For example, among the oxidizations of carbon nanotubes respectively for 3, 5, 7, and 9 minutes by gaseous fluid including O₃ at room temperature, the shorter time period for which the carbon nanotubes are oxidized, the better the carbon nanotubes are capable of emitting electrons, as can be seen from the 4 curves represented by □, Δ, [symbol] , and +. It may be understood that a prolonged oxidization of an array of carbon nanotubes by O₃ at room temperature leads to oxidative damage along the walls of the nanotubes, resulting in a decrease of current emission.

Experiments showed that as long as ambient temperature is equal to or higher than negative 50° C. (i.e., −50° C.), an array of carbon nanotubes can be oxidized by O₃ to significantly improve its capability of emitting electronic current (i.e., to be capable of emitting electronic current of higher density) under the same or lower onset emission voltage.

The cause of a carbon nanotube changing in shape (existent tips become sharper, or new tips or depressions are formed, for example) to be capable of emitting electrons of higher density under the same or lower onset emission voltage, is the cleavage of some C═C double bonds of carbon in the carbon nanotube, where C represents Carbon. The process according to the present invention is the unique art so far to cause the cleavage of C═C double bonds in a carbon nanotube for the carbon nanotube to work better with a display, or to be capable of emitting current of higher density under the same or lower onset emission voltage.

Although the experiments for the curves in FIGS. 5 and 7 are mainly based on oxidants of O₂ and O₃, the process according to the present invention is not necessarily limited to adopting O₂ and O₃ as oxidant, and may actually be implemented by an oxidant selected from among O₂, O₃, CO₂, NO₂, SO₂, and SO₃, or the combination of at least two thereof, or by whatever can cause the cleavage of some C═C double bonds of carbon in the carbon nanotube, where O, C, N, S respectively represents Oxygen, Carbon, Nitrogen, and Sulphur.

It is observed from experiments that the sharper a tip of a carbon nanotube is, the lower an onset emission voltage can be for current to be emitted therefrom, and the larger a current can be emitted therefrom.

Although oxidants in the form of liquid fluid may also be used for the oxidization according to the present invention, gaseous oxidants are preferred.

Obviously, to achieve the object of the present invention, it is not necessary to expose a whole carbon nanotube to oxidant in the process according to the present invention. For example, if only an end portion of a carbon nanotube is expected to emit electronic current, then only the end portion needs to be exposed to oxidant.

It can be understood the process of oxidizing an array of nanotubes by an oxidant (or a fluid including an oxidant) at an operating temperature higher ambient temperature may comprise the steps of:

heating the oxidant (or the fluid) until the oxidant (or the fluid) reaches the operating temperature; and

exposing at least part (an end portion, for example) of the nanotube to the oxidant (or the fluid) until the shape of at least part of the nanotube changes.

While the invention has been described in terms of what are presently considered to be the most practical and preferred embodiments, it shall be understood that the invention is not limited to the disclosed embodiment. On the contrary, any modifications or similar arrangements shall be deemed covered by the spirit of the present invention.

What is claimed is:

1. A process applied to a current emitting device having an end portion and being composed of material including carbon, comprising:
oxidizing said current emitting device at an operating temperature until the shape of at least part of said end portion changes, said operating temperature being higher than ambient temperature.

2. The process according to claim 1 wherein said current emitting device is in the shape of a tube.

3. The process according to claim 1 wherein said current emitting device is in the shape of a ball.

4. The process according to claim 1 wherein said current emitting device is a carbon nanotube.

5. The process according to claim 1 wherein said operating temperature is at least 70° C.

6. The process according to claim 1 wherein at least part of said end portion is exposed to a fluid composed of material including oxygen.

7. The process according to claim 6 wherein said fluid is gaseous material.

8. The process according to claim 6 wherein said fluid is at least one selected from among O₂, O₃, CO₂, NO₂, SO₂, and SO₃.

9. The process according to claim 1 wherein oxidizing said current emitting device comprises:
heating a fluid composed of material including oxygen until said fluid reaches said operating temperature; and
exposing at least part of said end portion to said fluid until the shape of at least part of said end portion changes.

10. The process according to claim 1 wherein the shape of said end portion changes in such a way that at least part of said end portion becomes to be in the shape of a tip.

11. The process according to claim 1 wherein the shape of said end portion changes in such a way that at least part of said end portion is depressed.

12. The process according to claim 1 wherein the shape of said end portion changes in such a way that the current emission capability of said end portion increases.

13. A process applied to a current emitting device composed of material including carbon, comprising:
oxidizing the current emitting device at an operating temperature until said current emitting device has at least part thereof changed in shape, said operating temperature being higher than ambient temperature.

14. The process according to claim 13 wherein said current emitting device is in the shape of a tube.

15. The process according to claim 13 wherein said current emitting device is in the shape of a ball.

16. The process according to claim 13 wherein said current emitting device is a carbon nanotube.

17. The process according to claim 13 wherein said operating temperature is at least 70° C.

18. The process according to claim 13 wherein at least part of said current emitting device is exposed to a fluid composed of material including oxygen.

19. The process according to claim 18 wherein said fluid is gaseous material.

20. The process according to claim 18 wherein said fluid is at least one selected from among O₂, O₃, CO₂, NO₂, SO₂, and SO₃.

21. The process according to claim 13 wherein oxidizing said current emitting device comprises:
heating a fluid composed of material including oxygen until said fluid reaches said operating temperature; and
exposing at least part of said current emitting device to said fluid until said current emitting device has at least part thereof changed in shape.

22. The process according to claim 13 wherein said current emitting device has the shape thereof changed in such a way that at least part thereof becomes to be in the shape of a tip.

23. The process according to claim 13 wherein said current emitting device has the shape thereof changed in such a way that at least part thereof is depressed.

24. The process according to claim 13 wherein said current emitting device has the shape thereof changed in such a way that the current emission capability of said current emitting device increases.

25. A process applied to a current emitting device composed of material including carbon, comprising:
oxidizing said current emitting device by a fluid including O₃ until said current emitting device has at least part thereof changed in shape.

26. The process according to claim 25 wherein said current emitting device is in the shape of a tube.

27. The process according to claim 25 wherein said current emitting device is in the shape of a ball.

28. The process according to claim 25 wherein said current emitting device is oxidized at a temperature which is at least negative 50° C.

29. The process according to claim 25 wherein the step of oxidizing said current emitting device comprises: providing a fluid including O₃ and being at a temperature which is at least negative 50° C.; and exposing at least part of said current emitting device to said fluid until the shape of said current emitting device changes.

30. The process according to claim 25 wherein said current emitting device has the shape thereof changed in such a way that at least part thereof becomes to be in the shape of a tip.

31. The process according to claim 25 wherein said current emitting device has the shape thereof changed in such a way that at least part thereof is depressed.

32. The process according to claim 25 wherein said current emitting device has the shape thereof changed in such a way that the current emission capability of said current emitting device increases.

33. A current emitting device comprising:
a surface having thereon at least one of carboxylic acid group (—COOH), hydroxyl group (—OH), and ketone group (>C═O); and
a body enclosed by said surface and composed of material including carbon.

34. The current emitting device according to claim 33 wherein said surface has at least a part thereof in the shape of a tip.

35. The current emitting device according to claim 33 wherein said surface has at least a part thereof depressed.

36. A process applied to a current emitting device composed of material including carbon, comprising:
splitting some C═C double bonds of carbon in said current emitting device until at least part of said current emitting device changes in shape.

37. The process according to claim 36 wherein said current emitting device changes in shape in such a way that the current emission capability thereof increases.
